(19) United States
(12) Patent Application Publication
(10) Pub. No.: US 2006/0219036 A1
(43) Pub. Date: Oct. 5, 2006

(54) Hypoid gear device

(75) Inventors: Hidekazu Michioka, Tokyo (JP); Masahiko Tamano, Tokyo (JP); Masayuki Imamura, Tokyo (JP); Takeki Shirai, Tokyo (JP); Daisuke Yatsushiro, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: THK CO., LTD.,, Tokyo (JP)

(21) Appl. No.: 10/552,725

(22) PCT Filed: Apr. 23, 2004
(86) PCT No.: PCT/JP04/05904

§ 371 Date: Oct. 11, 2005

(30) Foreign Application Priority Data
Apr. 25, 2003 (JP) 2003-122302
Jan. 15, 2004 (JP) 2004-8211

(51) Int. Cl. F16H 57/00

(52) U.S. Cl. 74/411

(57) ABSTRACT

A hypoid gear device is provided with a backlash eliminating unit arranged between a driven wheel and a driving pinion to be meshed with the driven wheel. The backlash eliminating unit includes a driven pinion mounted on the same shaft as that of the driving pinion so as to be meshed with the driven wheel, and an elastic member urging the driven pinion on the same shaft of the driving pinion in the direction reverse thereto.

### TECHNICAL FIELD

The present invention relates to a hypoid gear device.

### BACKGROUND ART

A hypoid gear device is adopted for transmitting rotation quietly and smoothly in comparison with a spiral gear by applying a sliding motion in a tooth trace direction to a rolling motion in the spiral gear and is utilized for driving of an axle of an automobile, rotation of a worktable of a machine tool, and the like (for example, refer to the following Patent Publications 1, 2 and 3).

In the hypoid gear device, backlash exists as like as in a usual gear, and for example, in the presence of the backlash, an indexing error is caused at a time of indexing a worktable. Then, in a prior art, such backlash has been eliminated by baking and grinding the hypoid gear device and then working it with high performance (for example, refer to the following Patent Publications 1 and 2). Moreover, such backlash has been eliminated by urging a small gear meshed with a large gear in an axial direction of the small gear by means of dish spring or like (for example, refer to the following Patent Publication 3).
Patent Publication 1: Japanese Patent Publication No. 3139133
Patent Publication 2: Japanese Utility Model Publication No. 3089532
Patent Publication 3: Japanese Utility Model Publication No. 3089706

However, it is difficult to substantially eliminate the backlash by baking and grinding the hypoid gear device and working it with high performance. In addition, in the arrangement in which the small gear is urged in its axial direction, since tooth surfaces of the small and large gears contact with each other at a large contacting pressure, the gear tooth will be easily worn.

### DISCLOSURE OF THE INVENTION

An object of the present invention is to provide a hypoid gear device capable of solving defective matters mentioned above.

In order to achieve the above object, the invention of claim 1 provides a hypoid gear device provided with a backlash eliminating unit for eliminating a backlash between a driven wheel and a driving pinion meshed with the driven wheel, the backlash eliminating unit comprising a driven pinion mounted on a same shaft as that of the driving pinion and meshed with the driven wheel, and an elastic member urging the driven pinion in a direction reverse to the driving pinion on the same shaft.

According to the invention of this claim 1, since the driving pinion and the driven pinion are urged by the elastic member in the directions reverse to each other on the same shaft, the driving pinion contacts one tooth flank of the driven wheel and, at the same time, the driven pinion contacts the other one tooth flank of the driven wheel, thus eliminating the backlash. In addition, since the driving pinion and driven pinion are applied with a preload by the elastic force of the elastic member, the increasing in the backlash due to the wearing of the tooth surface can be suppressed.

Furthermore, the invention of claim 2 provides a hypoid gear device provided with a backlash eliminating unit for eliminating a backlash between a driven wheel and a driving pinion meshed with the driven wheel, the backlash eliminating unit comprising a driven wheel composed of a plurality of ring members divided in a radial direction thereof, and an elastic member twisting the plurality of rings in directions reverse to each other.

According to the invention of this claim 2, since the inner and outer rings of the driven wheel are twisted by the elastic member in the directions reverse to each other on the same axis, the tooth flanks reverse to each other of the driven wheel contact, at the same time, the teeth of the driving pinion to thereby eliminate the backlash. In addition, since the driven wheel is applied with a preload by the elastic force of the elastic member, the increasing in the backlash due to the wearing of the tooth surface can be suppressed.

Furthermore, the invention of claim 3 provides a hypoid gear device provided with a backlash eliminating unit for eliminating a backlash between a driven wheel and a driving pinion meshed with the driven wheel, the backlash eliminating unit comprising a stationary gear rotating integrally with the driven wheel, a gear train transmitting a rotation of s shaft of the driving pinion to the stationary gear in a direction reverse to a rotating direction of the driven wheel, and a friction clutch arranged in a power transmission mechanism transmitting a driving power of a shaft of the driving pinion to the driven wheel through the gear train.

According to the invention of this claim 3, since the driving pinion rotates the driven wheel in one direction and, at this moment, the gear train slips, by the actuation of the friction clutch, and then urges the driven wheel in the reverse direction, the tooth flank of the driven wheel always contacts the tooth flank of the driving pinion, thereby eliminating the backlash.

Furthermore, the invention of claim 4 provides a hypoid gear device provided with a backlash eliminating unit for eliminating a backlash between a driven wheel and a driving pinion meshed with the driven wheel, the backlash eliminating unit comprising a driven pinion arranged to be meshed with the driven wheel, a gear train reversely transmitting a rotation of a shaft of the driving pinion to the driven pinion, and a friction clutch arranged in a power transmission mechanism transmitting a driving power of the shaft of the driving pinion to the driven wheel through the gear train.

According to the invention of this claim 4, since the driving pinion rotates the driven wheel in one direction and, at this moment, the driven pinion slips, by the actuation of the friction clutch, and then urges the driven wheel in the reverse direction, the driving pinion contacts one tooth flank of the driven wheel and, at the same time, the driven pinion always contacts the other side tooth flank of the driven wheel, thereby eliminating the backlash.

Furthermore, the invention of claim 5 provides a hypoid gear device provided with a backlash eliminating unit for eliminating a backlash between a driven wheel and a driving pinion meshed with the driven wheel, the driven wheel being supported to be rotatable with a shaft thereof and to be slidable thereon, and the backlash eliminating unit comprising an elastic member elastically deformable in an axial direction of the driven wheel to eliminate an overload as well as backlash.

According to the invention of this claim 5, since the driven wheel is supported to be rotatable around its shaft and slidalbe thereon, the backlash eliminating unit is elastically deformed in the axial direction of the driven wheel to thereby eliminate the backlash, and the elastic member for eliminating the overload is arranged, the backlash can be eliminated only by the engagement between the driven wheel and the driving pinion, and accordingly, the hypoid gear device can be easily assembled. In addition, at the time of overload, since the driven wheel slides on its shaft and is elastically deformed, thus absorbing the overload, so that any damage due to baking of the gear tooth can be appropriately prevented.

Furthermore, the invention of claim 6 provides the hypoid gear device of claim 5, in which the elastic member is formed as a spring.

According to the invention of this claim 6, since the elastic member is composed of the spring, the structure of the hypoid gear device can be made compact.

Furthermore, the invention of claim 7 provides the hypoid gear device of claim 5 or 6, in which the driven wheel is mounted on the shaft thereof through a spline mechanism.

According to the invention of this claim 7, since the driven wheel is mounted to its shaft through the spline mechanism, the rotation of the driving pinion is properly transmitted to the driven wheel, and in addition, at the time of overload, the driven wheel smoothly slides on its shaft to thereby prevent the overload from generating.

Furthermore, the invention of claim 8 provides the hypoid gear device according any one of claims 1 to 7, in which the driven wheel is mounted to a work table.

According to the invention of this claim 8, since the rotation of the driving pinion can be accurately transmitted to the work table through the driven wheel, the work table can be accurately and smoothly rotated and the indexing performance of the work table can be improved.

Furthermore, the invention of claim 9 provides the hypoid gear device according to any one of claims 1 to 8, in which the transmission of the rotation of the driven wheel to the driving pinion is prohibited.

According to the invention of this claim 9, since the transmission of the rotation of the driven wheel to the driving pinion can be shut off, the rotation of the work table is not transmitted to the driving pinion, and hence, the work table can be maintained in its stationary condition.

### BRIEF DESCRIPTION OF THE DRAWINGS

FIG. 1 is a vertical sectional view of a work table equipped with a hypoid gear device according to a first embodiment 1 of the present invention.

FIG. 2 is a schematic structural view of the hypoid gear device according to the first embodiment 1.

FIG. 3, including FIGS. 3A and 3B, shows schematic structural views of a hypoid gear device according to a second embodiment 2 of the present invention.

FIG. 4, including FIGS. 4A and 4B, shows schematic structural views of a hypoid gear device according to a third embodiment 3 of the present invention.

FIG. 5 is a schematic structural view of the hypoid gear device according to a fourth embodiment 4 of the present invention.

FIG. 6 shows a schematic structural view of a hypoid gear device according to fifth embodiment 5 of the present invention.

FIG. 7 is a plan view, partially cut away, of a wok table provided with a hypoid gear device according to a sixth embodiment 6 of the present invention.

FIG. 8 is vertical sectional view of the work table shown in FIG. 7.

### BEST MODE FOR EMBODYING THE INVENTION

Hereunder, the preferred embodiments of the present invention will be described with reference to the accompanying drawings.

### First Embodiment 1

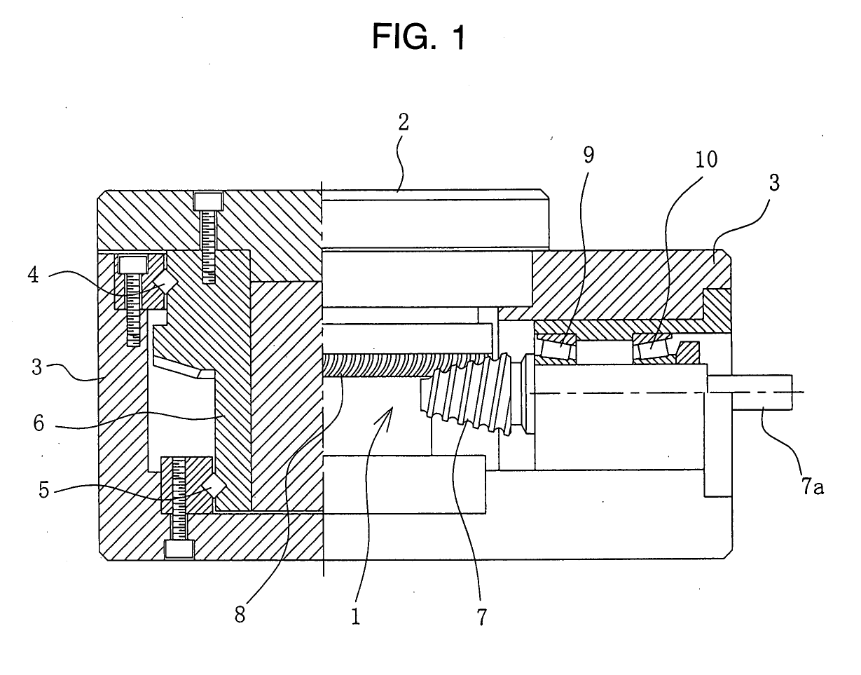

As shown in FIG. 1, a hypoid gear device 1 is used as transmission or gearing for rotating a work table 2 of a table device.

This work table 2 is for fixing a work, not shown, to be worked by a machine tool, in which the work table 2 is fixed to an upper end portion of a rotating shaft 6 supported vertically to a machine frame 3 through various kinds of bearings 4, 5.

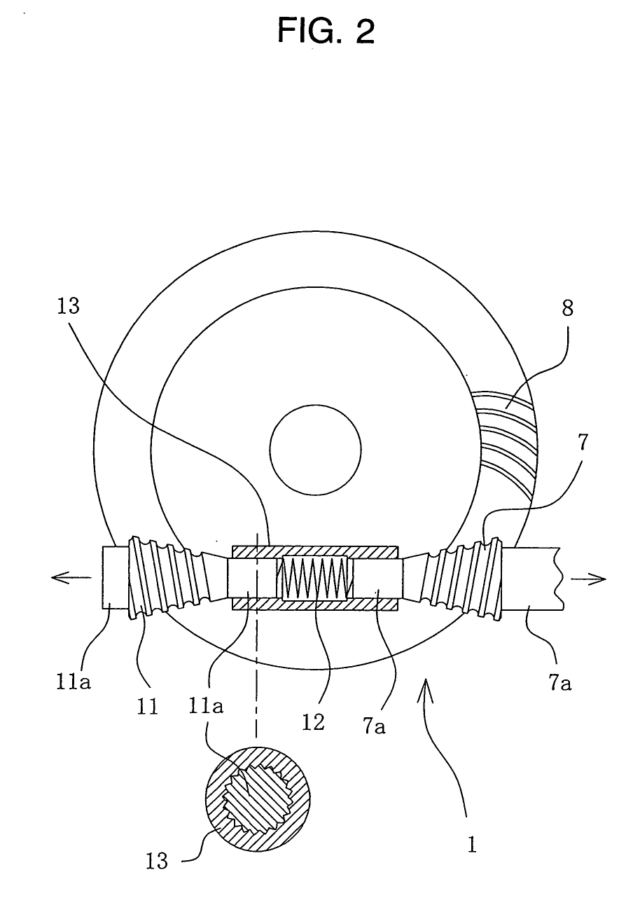

As shown in FIGS. 1 and 2, the hypoid gear device 1 is composed of a driving small gear (i.e., pinion) 7 and a driven large gear (i.e., wheel) 8. The wheel 8 is fixed to a lower surface of the work table 2 so that the axis of the wheel 8 accords with that of the rotating shaft 6, and a shaft 7a of the pinion 7 is supported horizontally by way of the various kinds of bearings 9, 10.

When a control motor, not shown, is driven, the rotation of the motor is transmitted to the drive pinion 7 to the driven wheel 8 and then to the work table 2, which is then stopped after rotating by a predetermined angle. Thereafter, the machine tool works the work placed on the work table 2.

The hypoid gear device 1 of this embodiment has a structure such that the transmission of the rotation of the driven wheel 8 to the driving pinion 7 is interrupted. More specifically, for example, in a case of a speed reduction ratio of more than 1/40, an offset amount of the driving pinion 7 is set to be more than 30% of an outer diameter of the driven wheel 8. According to such arrangement, the transmission of the rotation from the driven wheel 8 to the driving pinion 7 is interrupted, and hence, it becomes possible to prevent the rotation of the work table 2 due to the inertia of the work table 2 or an external force to be applied to the work table 2 from transmitting to the driving pinion 7, thereby maintaining the stationary state of the work table 2.

Further, there exists a backlash, between the driven wheel 8 and the driving pinion 7 of the hypoid gear device 1 of the present invention, which adversely affects on indexing of the rotation or rotating angle of the work table 2.

In order to eliminate such defect, in the present embodiment 1, a backlash eliminating means is provided for the hypoid gear device 1 as shown in FIG. 2.

The backlash eliminating means is provided with a driven small gear (i.e., pinion) 11 mounted on the shaft 7a of the driving pinion 7 so as to be meshed with the driven wheel 8 and with a compression coil spring 12 as an elastic member urging the driven pinion 11 in against the driving pinion 7 in opposing directions on the same axis.

The driven pinion 11 and the driving pinion 7 are provided with tooth, respectively, which have shapes symmetric with each other, and the driven pinion 11 has a shaft 11a which is rotatably supported to the machine frame 3 by way of various bearings, not shown, of the kinds shown in FIG. 1 as bearings 9, 10.

Both end portions of the compression coil spring 12 as elastic member are coupled with the shaft 7a of the driving pinion 7 and the shaft 11a of the driven pinion 11, respectively. A rubber may be used, as such elastic member, in place of the compression coil spring 12. The driving pinion 7 and the driven pinion 11 are both meshed with the driven wheel 8 on the shaft 11a in the state urged by the compression coil spring 12 in the directions opposing to each other. The compression coil spring 12 is covered by a sleeve 13. The sleeve 13 has one end fixedly covering the shaft 7a projecting outward from the front end of the driving pinion 7 and another end fitted slidably to the shaft 11a formed with a serration projecting outward from the front end of the driven pinion 11.

As described above, in this embodiment 1, the driving pinion 7 and the driven pinion 11 are urged by the compression coil spring 12, as elastic member, in the directions opposing to each other on the same shafts 7a and 11a as shown with arrows in FIG. 2, to be slidable by the action of the serration, so that the driving pinion 7 contacts one tooth flank of the tooth of the driven wheel 8 and, simultaneously, on the other hand, the driven pinion 11 contacts another tooth flank, opposing to the above mentioned one tooth flank, of the driven wheel 8, whereby the backlash can be substantially eliminated regardless of the rotating direction of the driving pinion 7. In addition, according to the fitting of the serration to the sleeve 13, the rotation of the driving pinion 7 can be transmitted to the driven pinion 11 with no backlash, thus more effectively and surely eliminating the backlash. Accordingly, the rotation of the driving pinion 7 can be precisely transmitted to the work table 2 by way of the driven wheel 8, and hence, the work table 2 can be accurately and smoothly rotated.

### Second Embodiment 2

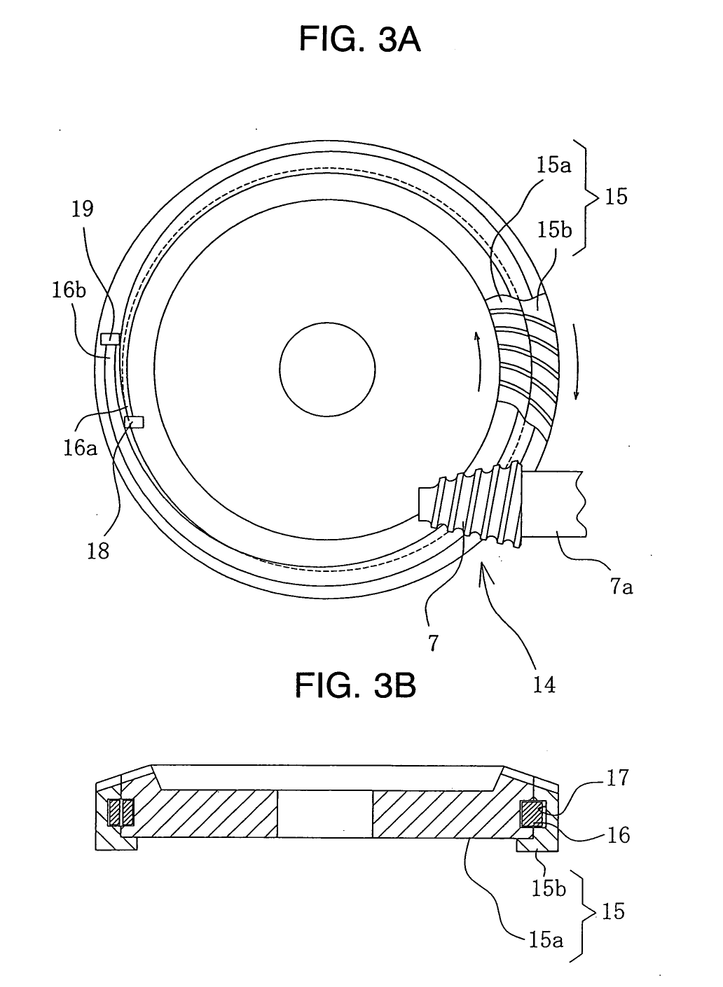

A hypoid gear device 14 according to the second embodiment 2 of the present invention differs from the first embodiment 1, as shown in FIGS. 3A and 3B, in that the backlash eliminating means of this second embodiment 2 is provided with a driven wheel 15 composed of a plurality of ring members 15a, 15b divided in its radial direction and a plate spring 16, as elastic member, for twisting the plural ring members 15a, 15b in directions opposing to each other.

More specifically, the driven wheel 15 is divided in its radial direction into inner and outer ring members 15a and 15b, which are fitted to each other so as to be relatively rotatable about the axis thereof.

The plate spring 16, as elastic member, is bent in form of ring. As shown in FIG. 3B, an annular accommodation chamber 17 for accommodating therein the plate spring 16 is formed at a boundary portion between the inner and outer ring members 15a and 15b of the driven wheel 15, and as shown in FIG. 3A, engaging pieces 18 and 19 are fixed to the accommodation chamber 17 on both the inner and outer ring member sides, respectively. The plate spring 16 is accommodated in this accommodation chamber 17 such that both end portions 16a and 16b thereof are engaged with the engaging pieces 18 and 19, respectively. The teeth of the inner and outer ring members 15a and 15b of the driven wheel 15 contact the teeth of the driving pinion 7 in a state twisted in directions opposing to each other around the axis thereof by the elastic force of the plate spring 16 in its twisting direction.

As described above, according to the arrangement of this second embodiment, the inner and outer ring members 15a and 15b of the driven wheel 15 are twisted around the axis thereof in the directions opposing to each other by the plate spring 16, as elastic member, the opposing teeth flanks of the driven wheel 15 simultaneously contact the teeth of the driving pinion 7, thereby eliminating the backlash. In addition, by the elastic force of the plate spring 16 as elastic member in its twisting direction, a preload in substantially the tangential direction to the tooth flank of the driven wheel 15 is applied to the driven wheel 15, thereby suppressing the increasing in the backlash due to the wearing of the tooth flanks.

Further, the same reference numerals are applied to the portions or elements of the hypoid gear device 1 of this second embodiment 2 corresponding to those of the first embodiment 1, and repeated description is omitted herein.

### Third Embodiment 3

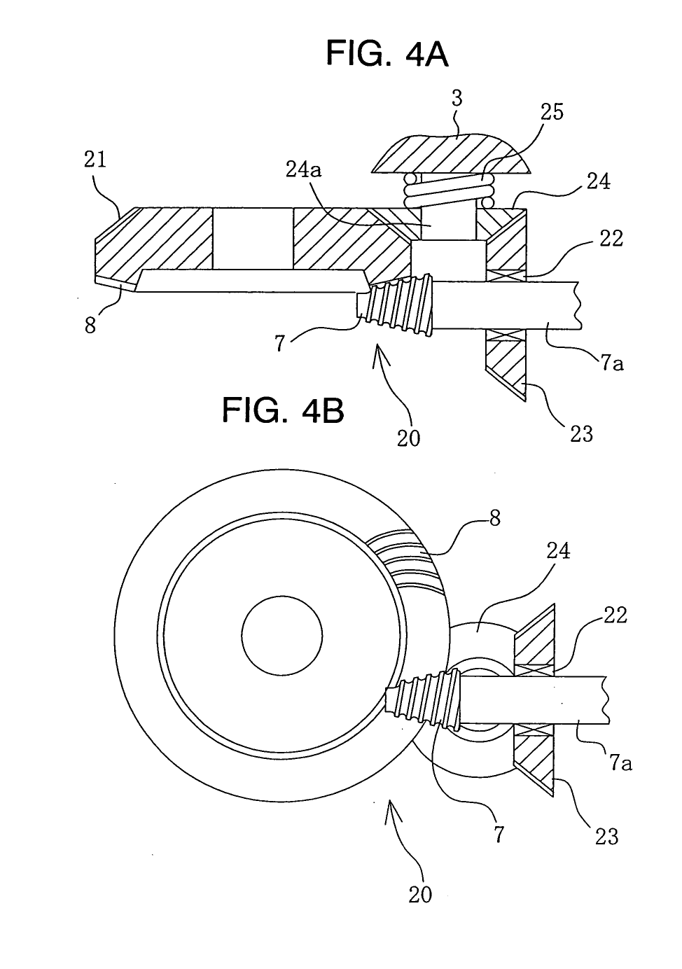

As shown in FIGS. 4A and 4B, the hypoid gear device 20 of this third embodiment 3 differs from the first embodiment 1 in that the backlash eliminating device is composed of a stationary gear 21 rotatable integrally with the driven wheel 8, a gear train transmitting the rotation of the driving pinion 7 to the stationary gear 21 in a direction reverse to that of the driven wheel 8, and a friction clutch 22 disposed in the power transmission system ranging from the driving pinion 7 to the driven wheel 8 through the gear train.

The stationary gear 21 is formed to the back surface of the driven wheel 8, being the hypoid gear, as a spiral bevel gear integrally with the driven wheel 8.

The gear train includes an odd number of bevel gears including the stationary gear 21. In this third embodiment 3, two, i.e., first and second, bevel gears 23 and 24 are disposed. These bevel gears 23 and 24 are formed as spiral bevel gears as like as the stationary gear 21. The arrangement of the odd number of bevel gears including the stationary gear 21 permits the stationary gear to rotate in the direction reverse to the rotating direction of the driven wheel 8 meshed with the driving pinion 7.

The first bevel gear 23 is mounted on the shaft 7a of the driving pinion 7 through the friction clutch 22, and on the other hand, the second bevel gear 24 is journaled to the machine frame 3 so as to be meshed with both of the first bevel gear 23 and the stationary gear 21. A shaft 24a of the second bevel gear 24 is idly fitted to the machine frame 3 and is urged, by a compression coil spring 25 wound around the shaft 24a, towards the first bevel gear 23 and the stationary gear 21. The driven wheel 8 is rotated in one direction by the rotation of the driving pinion 7. However, since the stationary gear 21 is rotated in the direction reverse to the rotating direction of the driven wheel 8 by the rotations of the first and second bevel gears 23 and 24, the first bevel gear 23 slips by the friction clutch 22 mounted on the shaft 7a and applies breaking force to the stationary gear 21.

As mentioned above, according to this embodiment, the driving pinion 7 rotates the driven wheel 8 in one direction and, in this period, the first bevel gear 23 of the gear train slips by the action of the friction clutch 22 and urges the driven wheel 8 in the reverse direction, so that the tooth flank of the driven wheel 8 always contacts the tooth flank of the driving pinion 7, thereby eliminating the backlash.

Further, it is to be noted that, in this third embodiment 3, the same reference numerals are added to portions or members corresponding to those of the hypoid gear device 1 of the first embodiment 1, and repeated description is now omitted herein.

### Fourth Embodiment 4

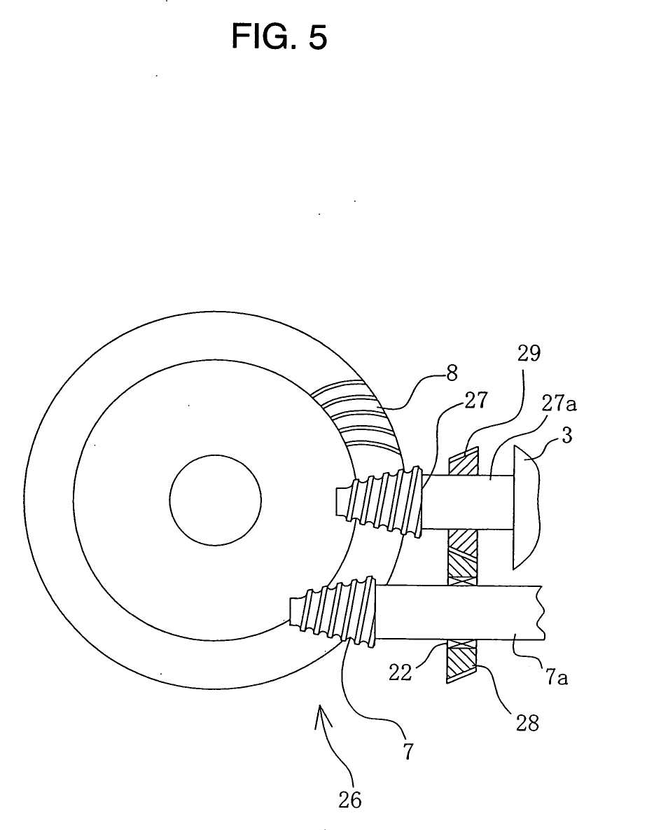

As shown in FIG. 5, the hypoid gear device 26 of this fourth embodiment 4 differs from the third embodiment 3 in that the backlash eliminating device is composed of a driven small gear, i.e., pinion, 27 meshed with the driven wheel 8, a gear train transmitting the rotation of the driving pinion 7 to the driven pinion 27 in a direction reverse to that of the driven pinion 27, and a friction clutch 22 disposed in the power transmission system ranging from the shaft 7a of the driving pinion 7 to the driven wheel 8 through the gear train.

The driven pinion 27 is formed as a spiral bevel gear to be meshed with the driven wheel 8 as a hypoid gear. The driven pinion 27 as the spiral bevel gear is meshed with the driven wheel 8 with no offset and a shaft 27a thereof is arranged so as to extend in parallel with the shaft 7a of the driving pinion 7.

The gear train includes an odd number of bevel gears including the driven pinion 27. In this fourth embodiment 4, two, i.e., first and second, bevel gears 28 and 29 are disposed. The arrangement of the odd number of bevel gears including the driven bevel gear 27 permits the driven pinion 27 to rotate in the direction reverse to the rotating direction of the driven wheel 8 meshed with the driving pinion 7.

The first bevel gear 28 is mounted on the shaft 7a of the driving pinion 7 through the friction clutch 22, and on the other hand, the second bevel gear 24 is fixed to the shaft 27a of the driven pinion 27. The shaft 27a of the driven pinion 27 is journaled to the machine frame 3 to be rotatable. The driven wheel 8 is rotated in one direction by the rotation of the driving pinion 7. However, since the driven pinion 27 is rotated in the direction reverse to the rotating direction of the driving pinion 7 by the rotations of the first and second spiral bevel gears 28 and 29, the first spiral bevel gear 28 slips by the friction clutch 22 mounted on the shaft 7a and applies breaking force to the driven wheel 8.

As mentioned above, according to this embodiment, the driving pinion 7 rotates the driven wheel 8 in one direction and, in this period, the driven pinion 27 is idly rotated by the action of the friction clutch 22 and urges the driven wheel 8 in the reverse direction, so that the driving pinion 7 contacts one side of the tooth flank of the driven wheel 8 and, on the other hand, the driven pinion 27 always contacts the other side of the tooth flank of the driven wheel 8, thereby eliminating the backlash.

Further, it is to be noted that, in this fourth embodiment 4, the same reference numerals are added to portions or members corresponding to those of the hypoid gear device 1 of the first embodiment 1, and repeated description is now omitted herein.

### Fifth Embodiment 5

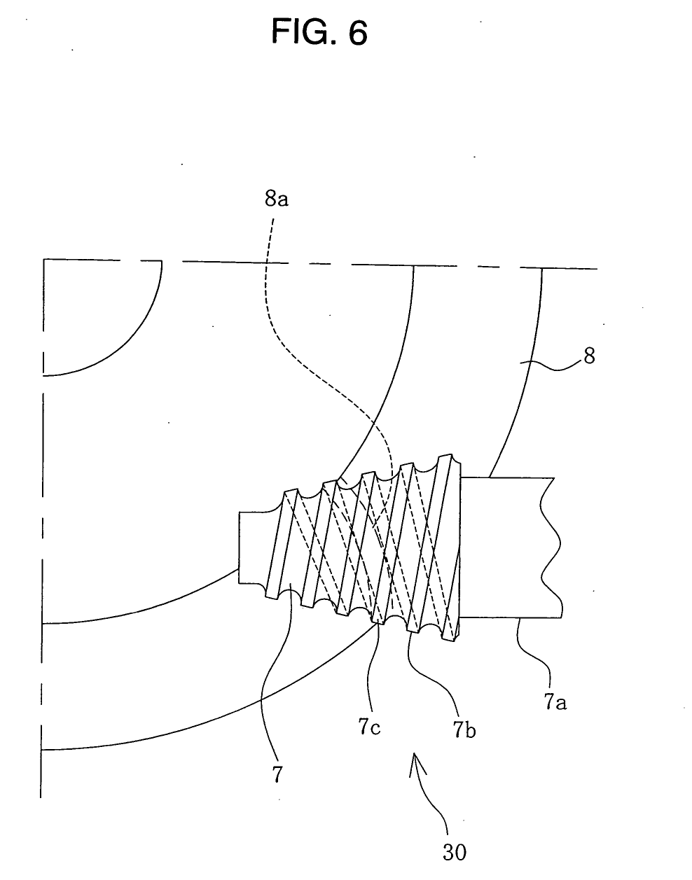

As shown in FIG. 6, a hypoid gear device 30 of this fifth embodiment 5 differs from any one of the afore-mentioned embodiments 1-4 in that the backlash eliminating device is composed of multi-thread teeth 7b and 7c meshed with the driven wheel 8. The backlash can be eliminated by clamping the tooth 8a of the driven wheel 8 with the multi-thread teeth 7b and 7c from both sides thereof. In the illustrated example, although the driving pinion 7 has two-thread tooth, it may be provided with three- or more than three-tread tooth.

Further, it is to be noted that, in this fifth embodiment 5, portions or members with no reference numerals are substantially the same as those in the other embodiments mentioned hereinbefore, and repeated description is therefore omitted herein.

### Sixth Embodiment 6

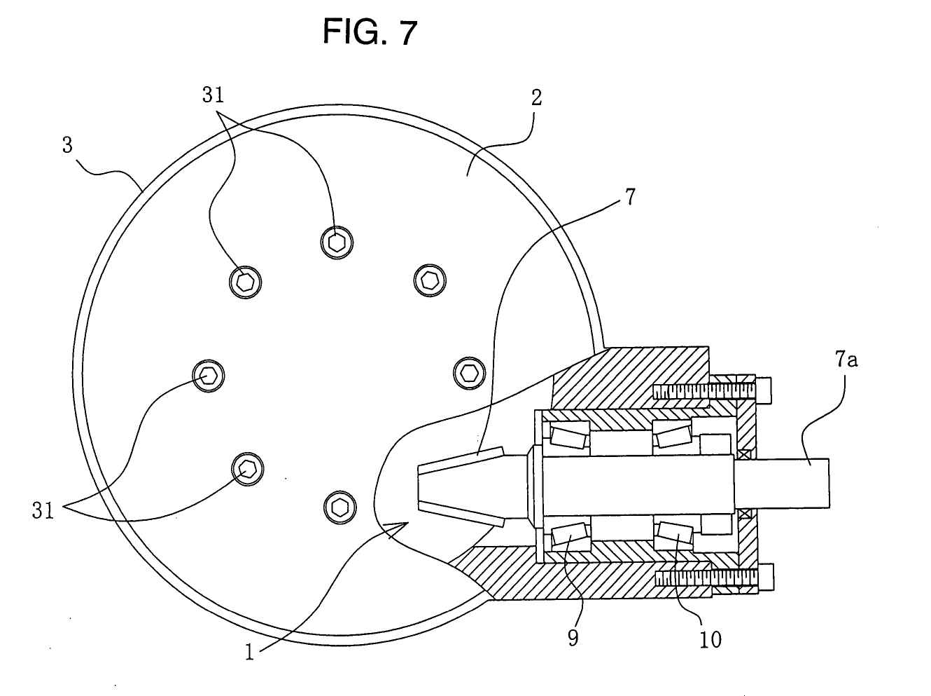

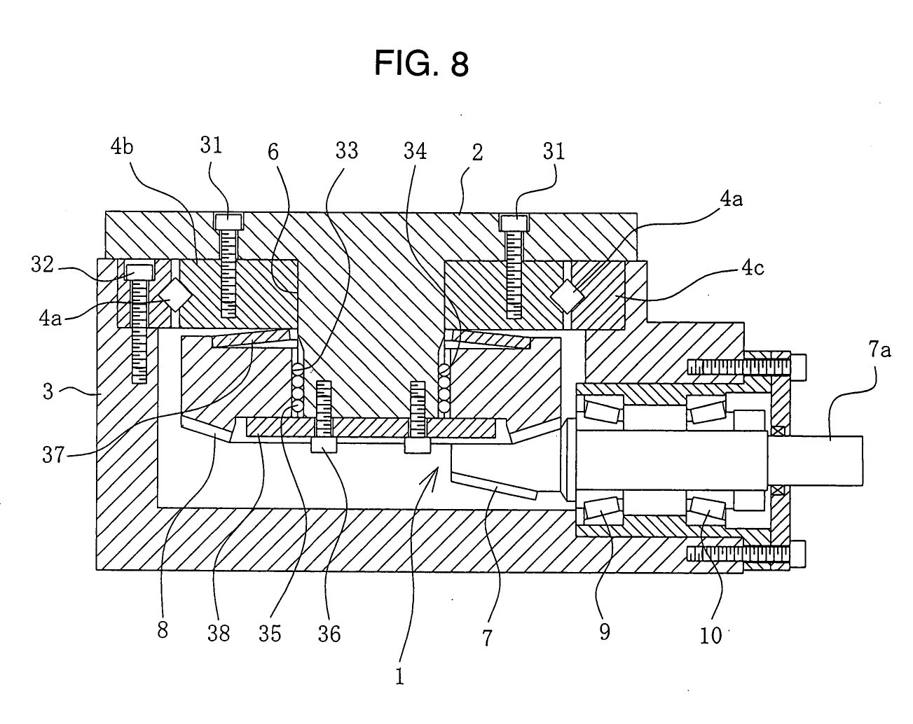

As shown in FIGS. 7 and 8, in this sixth embodiment 6, the hypoid gear device 1 is utilized as a power transmission device for rotating a work table 2 of a table device.

This work table 2 is a table for fixing a work, not shown, to be worked by a machine tool and is supported horizontally to the machine frame 3 through a bearing 4. The bearing 4 is provided with inner and outer rings 4b and 4c between which a roller 4a is clamped, in which the inner ring 4b is fastened to the work table 2 by means of fixing screw 31 and the outer ring 4c is fastened to the machine frame 3 by means of another fixing screw 32. According to such structure, the work table 2 is rotatable on the machine frame 3.

As shown in FIG. 8, the hypoid gear 1 is provided with the driving pinion 7 and the driven wheel 8.

The driven wheel 8 is mounted, through a spline mechanism, on the lower end portion of the shaft 6 extending downward, through the inner ring 4b, from the central portion of the work table 2. This spline mechanism is composed of grooves 33 and 34 formed to both the driven wheel 8 and the shaft 6 along their axial directions and balls 35 interposed between these grooves 33 and 34. According to the arrangement of such spline mechanism, the driven wheel 8 and the shaft 6 are rotatable together, i.e., integrally rotatable, and simultaneously, relatively slidable on the shaft 6 further, a press plate 38 is fixed to the lower end portion of the shaft 6 by means of fastening screw 36 and the driven wheel 8 is supported from the lower side by this press plate 38.

The driving pinion 7 is integrated with the shaft 7a, which is then horizontally supported by the machine frame 3 through various bearings 9 and 10.

When the control motor, not shown, is driven, the revolution of the motor is transmitted from the driving pinion 7 to the driven wheel 8 and then to the work table 2, which is then rotated by a predetermined angle and stops. Thereafter, the machine tool is operated to work a work on the work table 2.

In the hypoid gear device 1, between the driven wheel 8 and the driving pinion 7 meshed with the driven wheel 8, there exists a backlash, which adversely affects on the rotation of the work table 2 or indexing of the rotation angle thereof.

Then, in this embodiment, as shown in FIG. 8, a backlash eliminating device is provided for the hypoid gear device 1.

This backlash eliminating device is composed of the spline mechanism of the structure mentioned above and an elastic member, which will be described hereunder.

The elastic member in this embodiment is a dish spring 37, which is mounted around the shaft 6 and clamped in the vertical direction between the work table 2 and the driven wheel 8. Other springs such as compression coil spring may be utilized as the elastic member in place of the dish spring 37, and a rubber material may be utilized other than the spring.

This dish spring 37 as the elastic member is clamped to be elastically deformable between the work table 2 and the driven wheel 8. That is, at a time when the inner and outer rings 4b and 4c of the bearing 4 are fixed to the work table 2 and the machine frame 3, respectively, by means of fixing screws 31 and 32, the dish spring 37 is compressed and then elastically deformed in the axial direction of the driven wheel 8 by the work table 2 and the machine frame 3. According to the elastic deformation of the dish spring 37, the driven wheel 8 slides on its shaft 6 by the action of the spline mechanism and abuts against the press plate 35, so that the teeth of the driven wheel 8 are meshed with the teeth of the driving pinion 7 with the backlash being eliminated. The rotation of the driving pinion 7 is therefore transmitted accurately to the work table 2 through the driven wheel 8. Furthermore, even if an overload is caused between the driving pinion 7 and the driven wheel 8, the driven wheel 8 slides on its shaft 6 so as to be raised above the press plate 38 by the actuation of the spline mechanism, so that the overload is absorbed by the elastic deformation of the dish spring 37, and the driving pinion 7 and the driven wheel 8 can be prevented from being baked.

Further, portions or members which are not shown in this sixth embodiment are substantially the same as those in the other embodiments mentioned hereinbefore, and repeated description is therefore omitted herein.

It is to be understood that various modifications of the embodiments of the present invention described herein may be applied for the enforcement of the invention. As mentioned, the scope of claims defines the scope of the invention, and accordingly, it is intended that structures and those equivalent thereto included in the claims are included also in the scope of the invention.

It is further noted that this application is based upon and claims the benefit of priority from prior Japanese Patent Application Nos. 2003-122302 filed on Apr. 25, 2003 and 2004-8211 filed on Jan. 15, 2004, and the entire contents of the specifications, claims, drawings and abstracts thereof are incorporated herein by reference.

1. A hypoid gear device provided with a backlash eliminating unit for eliminating a backlash between a driven wheel and a driving pinion meshed with the driven wheel, said backlash eliminating unit comprising a driven pinion mounted on a same shaft as that of the driving pinion and meshed with the driven wheel, and an elastic member urging the driven pinion in a direction reverse to the driving pinion on the same shaft.

2. A hypoid gear device provided with a backlash eliminating unit for eliminating a backlash between a driven wheel and a driving pinion meshed with the driven wheel, said backlash eliminating unit comprising a driven wheel composed of a plurality of ring members divided in a radial direction thereof, and an elastic member twisting the plurality of rings in directions reverse to each other.

3. A hypoid gear device provided with a backlash eliminating unit for eliminating a backlash between a driven wheel and a driving pinion meshed with the driven wheel, said backlash eliminating unit comprising a stationary gear rotating integrally with the driven wheel, a gear train transmitting a rotation of s shaft of the driving pinion to the stationary gear in a direction reverse to a rotating direction of the driven wheel, and a friction clutch arranged in a power transmission mechanism transmitting a driving power of a shaft of the driving pinion to the driven wheel through the gear train.

4. A hypoid gear device provided with a backlash eliminating unit for eliminating a backlash between a driven wheel and a driving pinion meshed with the driven wheel, said backlash eliminating unit comprising a driven pinion arranged to be meshed with the driven wheel, a gear train reversely transmitting a rotation of a shaft of the driving pinion to the driven pinion, and a friction clutch arranged in a power transmission mechanism transmitting a driving power of the shaft of the driving pinion to the driven wheel through the gear train.

5. A hypoid gear device provided with a backlash eliminating unit for eliminating a backlash between a driven wheel and a driving pinion meshed with the driven wheel, said driven wheel being supported to be rotatable with a shaft thereof and to be slidable thereon, and said backlash eliminating unit comprising an elastic member elastically deformable in an axial direction of the driven wheel to eliminate an overload as well as backlash.

6. The hypoid gear device according to claim 5, wherein the elastic member is a spring.

7. The hypoid gear device according to claim 5 or 6, wherein the driven wheel is mounted on the shaft thereof through a spline mechanism.

8. The hypoid gear device according any one of claims 1 to 6 wherein the driven wheel is mounted to a work table.

9. The hypoid gear device according to any one of claims 1 to 6, wherein a transmission of rotation of the driven wheel to the driving pinion is prohibited.
